(19) United States
(12) Patent Application Publication
(10) Pub. No.: US 2010/0299112 A1
(43) Pub. Date: Nov. 25, 2010

(54) METHOD FOR STRAIN RATE DEPENDENCE ANALYSIS

(75) Inventors: Robert Goldberg, Strongsville, OH (US); Wieslaw Binienda, Akron, OH (US); Aditi Chattopadhyay, Tempe, AZ (US); Kelly S. Carney, Grafton, OH (US)

Correspondence Address: Joseph J. Crimaldi;Roetzel & Andress, 222 S. Main St., Akron, OH, 44308, US

(73) Assignee: THE UNIVERSITY OF AKRON, AKRON, OH (US)

(21) Appl. No.: 12/065,338

(22) PCT Filed: Sep. 11, 2006
(86) PCT No.: PCT/US2006/035315

§ 371 Date: Aug. 17, 2010

Related U.S. Application Data
(60) Provisional application No. 60/715,508, filed on Sep. 9, 2005.

(51) Int. Cl. G06F 17/10

(52) U.S. Cl. 703/2

(57) ABSTRACT

The present invention relates to a method for strain rate dependence analysis in various materials. In one embodiment, the present invention relates to a method for strain rate dependence analysis for polymer matrix composites (e.g., polymer composites used in the aerospace, sporting goods, and automotive industries).

### FIELD OF THE INVENTION

The present invention relates to a method for strain rate dependence analysis in various materials. In one embodiment, the present invention relates to a method for strain rate dependence analysis for polymer matrix composites (e.g., polymer composites used in the aerospace, sporting goods, and automotive industries).

### BACKGROUND OF THE INVENTION

Due to their low weight and high strength properties, fiber-reinforced polymer matrix composites are gaining wider usage in the aerospace, sporting goods, and automotive industries. In their applications to some primary aircraft structures, such as the radome and the fan containment system of jet engines, the mechanical properties of these materials under high strain rate impact conditions have attracted more attention in the composites community. The deformation of polymer composites is often assumed to be linear elastic and independent of strain rate in transient dynamic finite element codes used for impact analysis. However, many researchers have observed through experiments that the modulus and strength of the composites increase with increasing strain rate (see, e.g., (1) H. M. Hsiao et al. Strain Rate Behavior of Composite Materials, Composites Part B, 29B, 1998, pp. 521-533; (2) V. P. W. Shim et al., Dynamic Mechanical Properties of Fabric Armour, International Journal of Impact Engineering, 25, 2001, pp. 1-15; and (3) Ö. Akil et al., Effect of Strain Rate on the Compression Behaviour of a Woven Fabric S2-Glass Fiber Reinforced Vinyl Ester Composite, Polymer Testing, 22, 2003, pp. 883-887).

Polymers are known to have a strain rate dependent deformation response that is nonlinear above about one or two percent strain, which may result in the nonlinear, rate-dependent behavior of the polymer matrix composites. Traditionally, viscoelasticity models have been used to describe the nonlinear polymer behavior (see, e.g., (1) J. J. Aklonis et al., Introduction to Polymer Viscoelasticity, 2nd Edition, A Wiley-Interscience Publication, 1983; and (2) A. S. Wineman et al., Mechanical Response of Polymers, Cambridge University Press, New York, 2000). However, there has recently been an interest in the research community in adapting well-established plastic and viscoplastic constitutive equations for metals to model the nonlinear, strain rate sensitive deformation of polymers and polymer matrix composites (see, e.g., (1) S. V. Thiruppukuzhi et al., Models for the Strain-Rate-Dependent Behavior of Polymer Composites, Composites Science and Technology, 61, 2001, pp. 1-12; and (2) E. Krempl et al., A state Variable Model for High Strength Polymers”, Polymer Engineering and Science, Vol. 35, No. 4, pp. 310-316, 1995). This interest is due to the fact that despite the differences in the micro structure, similarities in the phenomelogical deformation behavior have been observed between metals and polymers.

Accordingly, there is a need in the art for a method for strain rate dependence analysis for polymer composites.

### SUMMARY OF THE INVENTION

The present invention relates to a method for strain rate dependence analysis in various materials. In one embodiment, the present invention relates to a method for strain rate dependence analysis for polymer matrix composites (e.g., polymer composites used in the aerospace, sporting goods, and automotive industries).

In one embodiment, a method for analyzing the strain rate dependence of a polymer composite, the method comprising the steps of: (A) a means for calculating at least one stress tensor value (σᵢⱼ), wherein the means employs the formula shown below:

$$\begin{matrix}[ \begin{matrix}{ɛ}_{11}^{e} \\ {ɛ}_{22}^{e} \\ {ɛ}_{33}^{e} \\ {ɛ}_{23}^{e} \\ {ɛ}_{13}^{e} \\ {ɛ}_{12}^{e}\end{matrix} ] = [ \begin{matrix}{ɛ}_{11} \\ {ɛ}_{22} \\ {ɛ}_{33} \\ {ɛ}_{23} \\ {ɛ}_{13} \\ {ɛ}_{12}\end{matrix} ] - [ \begin{matrix}{ɛ}_{11}^{I} \\ {ɛ}_{22}^{I} \\ {ɛ}_{33}^{I} \\ {ɛ}_{23}^{I} \\ {ɛ}_{13}^{I} \\ {ɛ}_{12}^{I}\end{matrix} ] \\ = [ \begin{matrix}\frac{1}{{E}_{m}} & - \frac{{v}_{m}}{{E}_{m}} & - \frac{{v}_{m}}{{E}_{m}} & 0 & 0 & 0 \\ - \frac{{v}_{m}}{{E}_{m}} & \frac{1}{{E}_{m}} & - \frac{{v}_{m}}{{E}_{m}} & 0 & 0 & 0 \\ - \frac{{v}_{m}}{{E}_{m}} & - \frac{{v}_{m}}{{E}_{m}} & \frac{1}{{E}_{m}} & 0 & 0 & 0 \\ 0 & 0 & 0 & \frac{2 ( 1 + {v}_{m} )}{{E}_{m}} & 0 & 0 \\ 0 & 0 & 0 & 0 & \frac{2 ( 1 + {v}_{m} )}{{E}_{m}} & 0 \\ 0 & 0 & 0 & 0 & 0 & \frac{2 ( 1 + {v}_{m} )}{{E}_{m}}\end{matrix} ] \\ [ \begin{matrix}{σ}_{11} \\ {σ}_{22} \\ {σ}_{33} \\ {σ}_{23} \\ {σ}_{13} \\ {σ}_{12}\end{matrix} ]\end{matrix}$$

where εᵢⱼ^{e} is the elastic strain tensor, εᵢⱼ^{I} is the inelastic strain tensor, εᵢⱼ is the total strain tensor which equals to the summation of εᵢⱼ^{e} and εᵢⱼ^{I}, Eₘ is the polymer modulus, and νₘ is the Poisson ratio; and (B) a means for utilizing the stress tensor value or values (σᵢⱼ) from Step (A) to derive at least one deviatoric stress component Sᵢⱼ.

In another embodiment, the present invention relates to a method for analyzing the strain rate dependence of a polymer composite, the method comprising the steps of: (i) a means for determining one or more material constants, wherein the means for determining one or more material constants include a storage means for storing the one or more material constants; (ii) a means for determining one or more strain increments, wherein the means for determining one or more strain increments include a second storage means for storing the one or more strain increments; and (iii) using the data for Step (i) and/or (ii) to analyze the strain rate dependence of a polymer composite.

### BRIEF DESCRIPTION OF THE DRAWINGS

FIG. 1 illustrates unit cells and slices in a micromechanical model;

FIG. 2 is a flowchart illustrating a user defined sub-routine that can be used to implement a material model within the LS-DYNA finite element code;

FIGS. 3(a) and 3(b) illustrate boundary and loading conditions for a single element;

FIG. 4 is a graph representing experimental and LS-DYNA simulated shear stress-shear strain curves for PR520 resin at strain rates of 7.0×10⁻⁵/s, 1.76/s and 420/s;

FIG. 5 is a graph representing experimental and LS-DYNA simulated tensile stress-strain curves for PR520 resin at strain rates of 5.0×10⁻⁵/s, 1.4/s and 510/s;

FIG. 6 is a graph representing experimental and LS-DYNA simulated shear stress-shear strain curves for 977-2 resin at strain rates of 9.0×10⁻⁵/s, 1.91/s and 518/s;

FIG. 7 is a graph representing experimental and LS-DYNA simulated tensile stress-strain curves for 977-2 resin at strain rates of 5.7×10⁻⁵/s, 1.31/s and 365/s;

FIGS. 8(a) and 8(b) are graphs representing the strain rate effect on polymer deformation behavior;

FIG. 9 is a graph representing experimental and LS-DYNA simulated tensile stress-strain curves for IM7/977-2 [10°] composite at strain rates of 0.56/s and 320/s;

FIG. 10 is a graph representing experimental and LS-DYNA simulated tensile stress-strain curves for IM7/977-2 [45°] composite at strain rates of 1.2/s and 405/s;

FIG. 11 is a graph representing experimental and LS-DYNA simulated tensile stress-strain curves for IM7/977-2 [90°] composite at strain rates of 1.09/s and 405/s;

FIG. 12 is a graph representing experimental and LS-DYNA simulated tensile stress-strain curves for IM7/977-2 [±45°]ₛ composite at strain rates of 9.0×10⁻⁵/s, 2.1/s and 604/s.

### DETAILED DESCRIPTION OF THE INVENTION

The present invention relates to a method for strain rate dependence analysis in various materials. In one embodiment, the present invention relates to a method for strain rate dependence analysis for polymer matrix composites (e.g., polymer composites used in the aerospace, sporting goods, and automotive industries).

In one embodiment, the method of the present invention is used to analyze isotropic polymers. However, it should be noted that the present invention is not limited to just this embodiment. Additionally, the isotropic polymers of the present invention may possess some degree of material anisotropy due to preferred orientations of molecular chains at finite deformations. The analysis conducted in accordance with the method of the present invention are done at room temperature (approximately 25° C.) with a relative humidity of about 40 percent.

To analyze the nonlinear, strain rate dependent deformation of the polymer matrix materials, the Bodner-Partom viscoplastic state variable model (see, S. R. Bodner, Unified Plasticity for Engineering Applications, Kluwer Academic/Plenum Publishers, New York, 2002), which was originally developed to analyze the viscoplastic deformation of metals above one-half of the melting temperature, is modified as discussed below.

In state variable models, a single unified strain variable is defined to represent all inelastic strains. Furthermore, in the state variable approach there is no defined yield stress. Inelastic strains are assumed to be present at all values of stress, the inelastic strains are just assumed to be very small in the “elastic” range of deformation. State variables, which evolve with stress and inelastic strain, are defined to represent the average effects of the deformation mechanisms.

In one embodiment of the present invention, an isotropic compliance matrix is used to relate the strains to the stresses using the following equation from which the stress tensor σᵢⱼ is calculated:

$$\begin{matrix}[ \begin{matrix}{ɛ}_{11}^{e} \\ {ɛ}_{22}^{e} \\ {ɛ}_{33}^{e} \\ {ɛ}_{23}^{e} \\ {ɛ}_{13}^{e} \\ {ɛ}_{12}^{e}\end{matrix} ] = [ \begin{matrix}{ɛ}_{11} \\ {ɛ}_{22} \\ {ɛ}_{33} \\ {ɛ}_{23} \\ {ɛ}_{13} \\ {ɛ}_{12}\end{matrix} ] - [ \begin{matrix}{ɛ}_{11}^{I} \\ {ɛ}_{22}^{I} \\ {ɛ}_{33}^{I} \\ {ɛ}_{23}^{I} \\ {ɛ}_{13}^{I} \\ {ɛ}_{12}^{I}\end{matrix} ] \\ = [ \begin{matrix}\frac{1}{{E}_{m}} & - \frac{{v}_{m}}{{E}_{m}} & - \frac{{v}_{m}}{{E}_{m}} & 0 & 0 & 0 \\ - \frac{{v}_{m}}{{E}_{m}} & \frac{1}{{E}_{m}} & - \frac{{v}_{m}}{{E}_{m}} & 0 & 0 & 0 \\ - \frac{{v}_{m}}{{E}_{m}} & - \frac{{v}_{m}}{{E}_{m}} & \frac{1}{{E}_{m}} & 0 & 0 & 0 \\ 0 & 0 & 0 & \frac{2 ( 1 + {v}_{m} )}{{E}_{m}} & 0 & 0 \\ 0 & 0 & 0 & 0 & \frac{2 ( 1 + {v}_{m} )}{{E}_{m}} & 0 \\ 0 & 0 & 0 & 0 & 0 & \frac{2 ( 1 + {v}_{m} )}{{E}_{m}}\end{matrix} ] \\ [ \begin{matrix}{σ}_{11} \\ {σ}_{22} \\ {σ}_{33} \\ {σ}_{23} \\ {σ}_{13} \\ {σ}_{12}\end{matrix} ]\end{matrix} \qquad ( 1 )$$

where εᵢⱼ^{e} is the elastic strain tensor, εᵢⱼ^{I} is the inelastic strain tensor, and εᵢⱼ is the total strain tensor which equals to the summation of εᵢⱼ^{e} and εᵢⱼ^{I}. Eₘ is the polymer modulus and νₘ is the Poisson ratio.

From σᵢⱼ, the deviatoric stress components Sᵢⱼ can be directly derived. The components of the inelastic strain rate tensor \dot{ε}ᵢⱼ^{I}, as shown in Equation (2), are defined as a function of Sᵢⱼ, the second invariant of the deviatoric stress tensor J₂, and an isotropic state variable Z, which represents the resistance to molecular flow.

$${\dot{ɛ}}_{ij}^{I} = 2 {D}_{0} exp [ - \frac{1}{2} {( \frac{Z}{{σ}_{e}} )}^{2 n} ] ( \frac{{S}_{ij}}{2 \sqrt{{J}_{2}}} + {αδ}_{ij} ) \qquad ( 2 )$$

where D₀ and n are both material constants, with D₀ representing the maximum inelastic strain rate and n controlling the rate dependence of the material. The effective stress σₑ is defined as

σₑ=\sqrt{3J₂}+\sqrt{3}ασₖₖ (3)

where α is a state variable controlling the level of the hydrostatic stress effects and σₖₖ is the summation of the normal stress components which equals three times the mean stress.

The evolution equations for the two state variables z and α can then be computed using the following equations:

Ż=q(Z₁−Z)ėₑ^{I} (4)

\dot{α}=q(α₁−α)ėₑ^{I} (5)

where q is a material constant representing the “hardening” rate, and Z₁ and α₁ are material constants representing the maximum value of z and a, respectively. The initial values of z and α are defined by the material constants Z₀ and α₀. The term ėₑ^{I} in Equation (4) and Equation (5), and Equation (5) represents the effective deviatoric inelastic strain rate, which is defined as

$${\dot{e}}_{e}^{I} = \sqrt{\frac{2}{3} {\dot{e}}_{ij}^{I} {\dot{e}}_{ij}^{I}} \\ {\dot{e}}_{ij}^{I} = {\dot{ɛ}}_{ij}^{I} - {\dot{ɛ}}_{m}^{I} \qquad ( 6 )$$

where \dot{ε}ₘ^{I} is the mean inelastic strain rate, which is equal to (\dot{ε}₁₁^{I}+\dot{ε}₂₂^{I}+\dot{ε}₃₃^{I})/3. In many state variable constitutive models developed to analyze the behavior of metals (see, e.g., D. C. Stouffer et al., Inelastic Deformation of Metals. Models, Mechanical Properties and Metallurgy, John Wiley and Sons, New York, 1996), the total inelastic strain and strain rate are used in the evolution laws and are assumed to be equal to their deviatoric values. As discussed by Li and Pan (see, F. Z. Li et al., Plane-Stress Crack-Tip Fields for Pressure-Sensitive Dilatant Materials, Journal of Applied Mechanics, 57, 1990, pp. 40-49), since hydrostatic stresses contribute to the inelastic strains in polymers, indicating volumetric effects are present, the mean inelastic strain rate cannot be assumed to be zero, as is the case in the inelastic analysis of metals.

The material constants in the above constitutive equations that need to be determined include D₀, n, Z₀, z₁, α₀, α₁ and q. The procedures to obtain these material constants can be found in Goldberg et al. (see R. K. Goldberg et al., Implementation of an Associative Flow Rule Including Hydrostatic Stress Effects into the High Strain Rate Deformation Analysis of Polymer Matrix Composites, NASA/TM-2003-212382, 2003). Besides these values, the elastic modulus and Poisson's ratio are also the input parameters required for the model as shown in Equation (1). However, the elastic modulus has been found to increase with increasing strain rate in both polymers and polymer matrix composites. Comparing the dynamic and static value of the initial modulus, Tay et al. found a two to three fold increase of the initial modulus of epoxy and an approximately three to five times increase in the initial modulus of glass fiber reinforced epoxy (see T. E. Tay et al., An Empirical Strain Rate-dependent Constitutive Relationship for Glass-Fibre Reinforced Epoxy and Pure Epoxy, Composite Structures, 33, 1995, pp. 201-210). Hsiao et al. observed an increase in the dynamic modulus and strength over the static values in a [90°] unidirectional carbon/epoxy laminate, primarily due to the rate dependence of the matrix (see H. M. Hsiao et al. Strain Rate Behavior of Composite Materials, Composites Part B, 29B, 1998, pp. 521-533). Akil et al. found the modulus and failure strength increased with increasing strain rate in both the in-plane and through thickness direction of a S2-glass woven fabric/vinyl ester composite plate (see Ö. Akil et al., Effect of Strain Rate on the Compression Behaviour of a Woven Fabric S2-Glass Fiber Reinforced Vinyl Ester Composite, Polymer Testing, 22, 2003, pp. 883-887). To account for this phenomenon, the constitutive equations need to be modified in order to include a strain rate dependent elastic modulus instead of a fixed modulus.

In their study of gelatin gum gels, Teratsubo et al. proposed a linear relationship between the natural logarithms of modulus and the inverse of strain rate (see M. Teratsubo et al., Measurement of Stress and Strain during Tensile Testing of Gellan Gum Gels: Effect of Deformation Speed, Carbohydrate Polymers, 47, 2002, pp. 1-5). Albérola et al. observed a strain rate threshold at 1 s⁻¹ for amorphous PEEK (see N. D. Albérola et al., Tensile Mechanical Properties of PEEK Films over a Wide Range of Strain Rates: II, Journal of Applied Polymer Science, Vol. 64, Issue. 6, 1997, pp. 1053-1059). For strain rates lower than 1 s⁻¹, the modulus is almost constant; while for strain rate higher than 1 s⁻¹, the modulus tends to markedly increase. In a recently developed model, Yen utilized the Johnson-Cook model commonly used to describe high strain rate behavior in metals to account for the effect of strain rate on the elastic moduli and strength values of a composite layer (see C. F. Yen, Ballistic Impact Modeling of Composite Materials, Proceedings of the 7th international LS-DYNA Users Conference, 2002). The revised equation used in this study to compute the effect of strain rate on the elastic modulus of polymer is as follows:

$$E = {E}_{0} ( 1 + C ln \frac{\dot{ɛ}}{{\dot{ɛ}}_{0}} ) \qquad ( 7 )$$

where C is a scaling material constant, E is the final elastic modulus, E₀ is the reference elastic modulus, \dot{ε}₀ is the reference effective strain rate and \dot{ε} is the applied effective strain rate. The effective strain rate is defined as:

$$\dot{ɛ} = \sqrt{\frac{2}{3} [ \begin{matrix}{( {\dot{ɛ}}_{11} - {\dot{ɛ}}_{m} )}^{2} + {( {\dot{ɛ}}_{22} - {\dot{ɛ}}_{m} )}^{2} + {( {\dot{ɛ}}_{33} - {\dot{ɛ}}_{m} )}^{2} + \\ 2 {\dot{ɛ}}_{12}^{2} + 2 {\dot{ɛ}}_{23}^{2} + 2 {\dot{ɛ}}_{13}^{2}\end{matrix} ]} \\ where , {\dot{ɛ}}_{m} = \frac{1}{3} ( {\dot{ɛ}}_{11} + {\dot{ɛ}}_{22} + {\dot{ɛ}}_{33} ) . \qquad ( 8 )$$

In the current model developed here, Equation (7) is utilized to modify Eₘ in Equation (1) based on the applied effective strain rate. Three new material constants are required for using this equation, including the reference modulus Eₒ, the reference effective strain rate \dot{ε}₀ and the strain rate constant C. \dot{ε}₀ and E₀ can be chosen by using tensile stress-strain curves obtained at relatively low strain rates, preferably around 1 s⁻¹ according to the findings of Albérola et al. (see N. D. Albérola et al., Tensile Mechanical Properties of PEEK Films over a Wide Range of Strain Rates: II, Journal of Applied Polymer Science, Vol. 64, Issue. 6, 1997, pp. 1053-1059). By using an additional stress-strain curve obtained at a higher strain rate, the constant C can be easily determined.

To compute the effective strain rate dependent, nonlinear deformation response of polymer matrix composites based on the response of the individual constituents, a micromechanical model has been developed. In this model, the unit cell is defined to consist of a single fiber and its surrounding matrix. Due to symmetry, only one-quarter of the unit cell is analyzed. The composites are assumed to have a periodic, square fiber packing with a perfect interfacial bond. The fibers are assumed to be transversely isotropic and linear elastic with a circular cross-section. The matrix is assumed to be isotropic, with a rate dependent, nonlinear deformation response computed using the equations described in the previous section of this article.

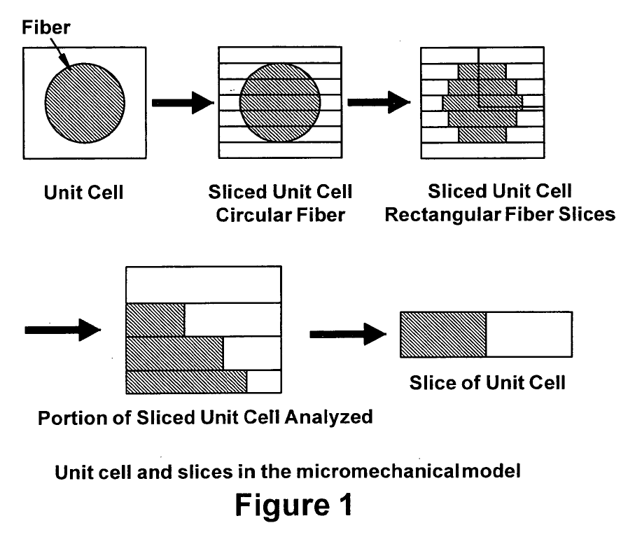

The unit cell is divided up into an arbitrary number of rectangular, horizontal slices, as is shown in FIG. 1. Each slice is assumed to be in a state of plane stress and classical laminate theory is assumed to be applicable at this scale. The top and bottom slices in the unit cell are composed of pure matrix. The remaining slices are composed of two sub-slices; one composed of fiber material and the other composed of matrix material. For the slices containing both fiber and matrix, the out-of-plane stresses can be nonzero in individual sub-slices, but the volume average of the out-of-plane stresses must be equal to zero. By using this approach, the behavior of each slice is decoupled, and the response of each slice can be determined independently, which significantly reduces the level of complexity in the analysis. Laminate theory is used to obtain the effective response of the unit cell.

The thickness, fiber volume ratio and thickness ratio (the ratio of the slice thickness to the total unit cell thickness) for each slice can be determined using the composite fiber volume ratio and geometric principles. The overall diameter of the fiber is related to the fiber volume fraction of the overall composite, and this term can be used along with the standard geometric definition of the radius of a circle to compute the horizontal coordinate of any point on the outer surface of the fiber in terms of the fiber volume fraction and the vertical coordinate. Using this information and standard calculus concepts, the area of the portion of the fiber contained within each slice of the one-quarter of the unit cell which is analyzed can be computed. The fiber diameter and fiber area within each slice can be used to compute the fiber volume fraction and thickness ratio of each slice.

The effective properties, effective stresses and effective inelastic strains of each slice are computed independently. Micromechanics equations are developed using uniform stress and uniform strain assumptions for those slices composed of both fiber and matrix material. The stresses and inelastic strains in the slices composed of pure matrix are computed using the matrix elastic properties and the inelastic constitutive equations. The standard transversely isotropic compliance matrix (or isotropic in the case of the matrix) is used to relate the local strains to the local stresses in the fiber and matrix. Each slice is assumed to be in a state of plane stress on the global level, but out-of-plane normal stresses can exist in each sub-slice. The responses of each slice are combined using laminate theory to obtain the effective response of the corresponding lamina. Laminate theory is applied once again to obtain the effective properties and force resultants due to inelastic strains for a multilayered composite laminate.

The composite model is developed for a single unidirectional lamina. Besides all of the material constants used in the polymer constitutive model, additional parameters required for this composite model include the fiber properties, including the tensile and shear modulus and Poisson's ratio, the fiber volume fraction and the number of fiber slices to be used in the unit cell.

The polymer constitutive equations and the micromechanical composite model described above have been implemented into LS-DYNA. LS-DYNA has a user defined material (UMAT) option where a user can implement a new material model as a subroutine. In one embodiment, the material models are implemented for shell elements, since normally a composite is a thin structure. With shell elements, it is also convenient to define fiber orientations of composite layers at through-thickness integration points. In addition, when dealing with a complex structure, shell elements are more computationally efficiency than solid elements.

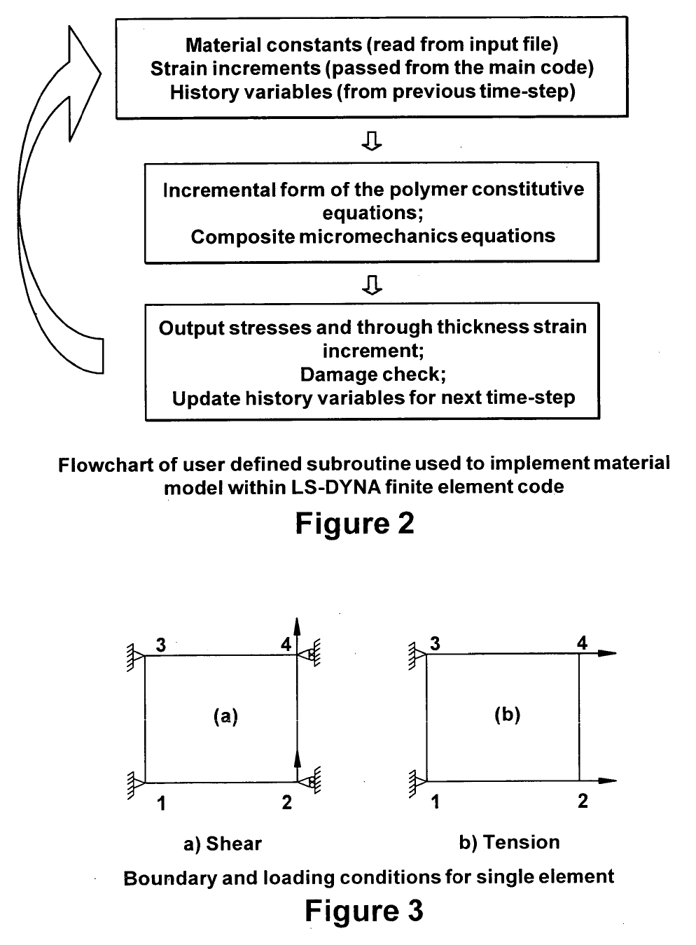

The structure of the sub-routine is shown in FIG. 2. The LS-DYNA code calculates the strain increments from boundary and loading conditions and passes them to the UMAT subroutine at the beginning of each time step. The material constants, such as moduli and Poisson's ratios, are read from the LS-DYNA input file by the subroutine. The history variables, which are passed through each time step, include the total strain, the inelastic strain for the polymer model (or the polymer matrix in each slice for the composite model), and the values of the state variables Z and α. By using the values of the history variables at the beginning of the time step, the material constants and the provided strain increments, the subroutine is able to compute the values of the stresses at the end of the time increment by using an incremental form of the polymer constitutive equations (and the composite micromechanics equations for the case of the composite model). To integrate the constitutive equations, a fourth order Runge-Kutta integrator is used due to its accuracy and explicit form. The subroutine then passes the updated values of the history variables to the next time step, and outputs the calculated stresses together with the through thickness strain increment for the shell element. If a damage model is implemented, at this point the subroutine would also check the damage and modify the material stiffness if damage occurs. The damage model will be presented in a future article. The procedure described above is carried out on each integration point of each element independently.

As a first step in model development, the polymer constitutive model was implemented into LS-DYNA as a UMAT in order to test its ability to predict the nonlinear, strain rate dependent deformation behavior of a representative polymer. After successfully implementing the polymer UMAT, a polymer matrix composite UMAT using the presented micromechanical model was developed. The composite UMAT is implemented by modeling a single lamina with a zero degree fiber orientation. Composite plies with varying fiber orientation angles can be specified by defining different angles for the through-thickness integration points in the LS-DYNA input deck.

### Model Verification:

To verify the polymer analytical model and its implementation within LS-DYNA, two representative toughened epoxies, PR520 and 977-2, were analyzed using LS-DYNA, and the computed stress-strain curves were compared to experimental results obtained by Goldberg, et al. (see R. K. Goldberg et al., Implementation of an Associative Flow Rule Including Hydrostatic Stress Effects into the High Strain Rate Deformation Analysis of Polymer Matrix Composites, NASA/TM-2003-212382, 2003). In the experimental tests, longitudinal tensile tests and pure shear tests were conducted at room temperature on the materials at strain rates of about 5.0×10⁻⁵/s, 1/s and 400/s. The low and moderate strain rate tests were conducted using an Instron hydraulic testing machine. The high strain rate tests were conducted using a split Hopkinson bar. Engineering stress and engineering strain were measured until failure.

In the finite element analyses, a four-node single Belytschko-Tsay shell element was used for the simulation of the pure shear and tension tests (see LS-DYNA Keyword User's Manual Version 940, Livermore Software Technology Corporation, Livermore, Calif., 1997). The load and boundary conditions applied to the model are shown in FIG. 3. The applied strain rate is controlled by the displacement-time curve defined in the LS-DYNA input file. Table 1 lists the material constants used in the model. With the exception of the material constants required for Equation (7), the remaining values of the material constants were taken from Goldberg, et al. (see R. K. Goldberg et al., Implementation of an Associative Flow Rule Including Hydrostatic Stress Effects into the High Strain Rate Deformation Analysis of Polymer Matrix Composites, NASA/TM-2003-212382, 2003). In determining the value of the strain rate constant C, tensile stress-strain curves obtained at two different strain rates are required.

For example, from the experimental data presented in Goldberg, et al. (see R. K. Goldberg et al., Implementation of an Associative Flow Rule Including Hydrostatic Stress Effects into the High Strain Rate Deformation Analysis of Polymer Matrix Composites, NASA/TM-2003-212382, 2003), the initial elastic modulus of PR520 was determined to be equal to 3.54 GPa for a lower tensile strain rate of 1.76/s and equal to 7.18 GPa for a higher tensile strain rate of 420/s. The lower effective strain rate calculated as 1.42/s was chosen to be the reference strain rate \dot{ε}₀ and its corresponding modulus 3.54 GPa was chosen to be the reference modulus E₀. Together with the other set of modulus data at the higher strain rate, the constant C was calculated by using Equation (7).

TABLE 1
Material constants used in polymer matrix modeling

| | \dot{ε}₀ | E₀ | | | Dₒ | | Zₒ | Z₁ | | | |
|---|---|---|---|---|---|---|---|---|---|---|---|
| | (1/s) | (GPa) | C | νₘ | (1/s) | n | (MPa) | (MPa) | q | αₒ | α₁ |
| PR520 | 1.42 | 3.54 | 0.1878 | 0.38 | 1 × 10⁶ | 0.93 | 396.09 | 753.82 | 279.26 | 0.568 | 0.126 |
| 977-2 | 1.55 | 3.52 | 0.1432 | 0.40 | 1 × 10⁶ | 0.85 | 259.50 | 1131.4 | 150.50 | 0.129 | 0.152 |

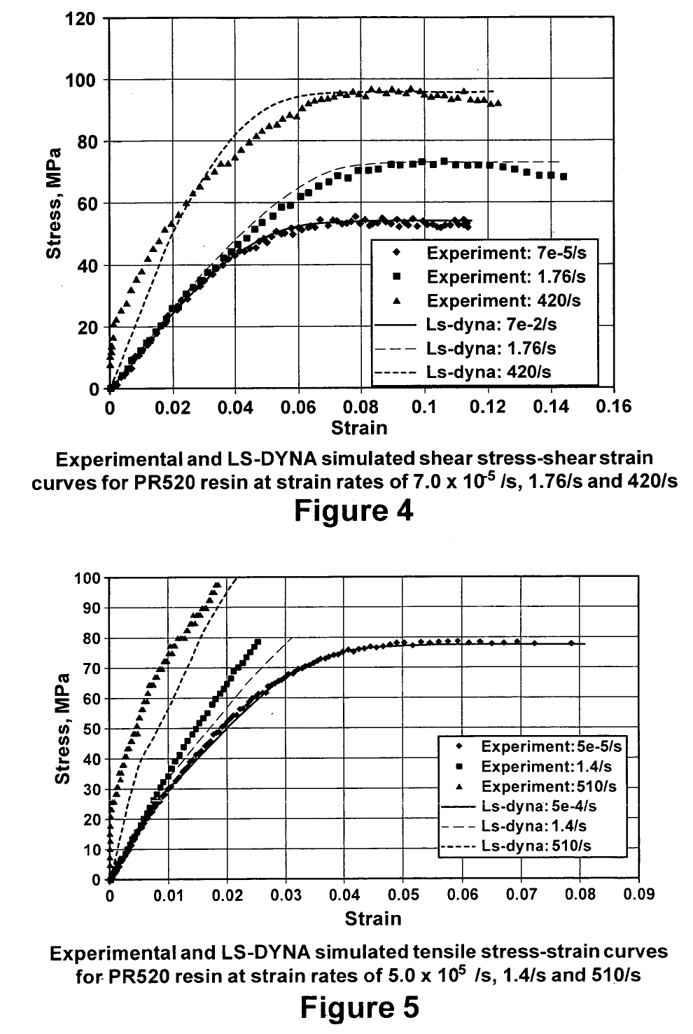

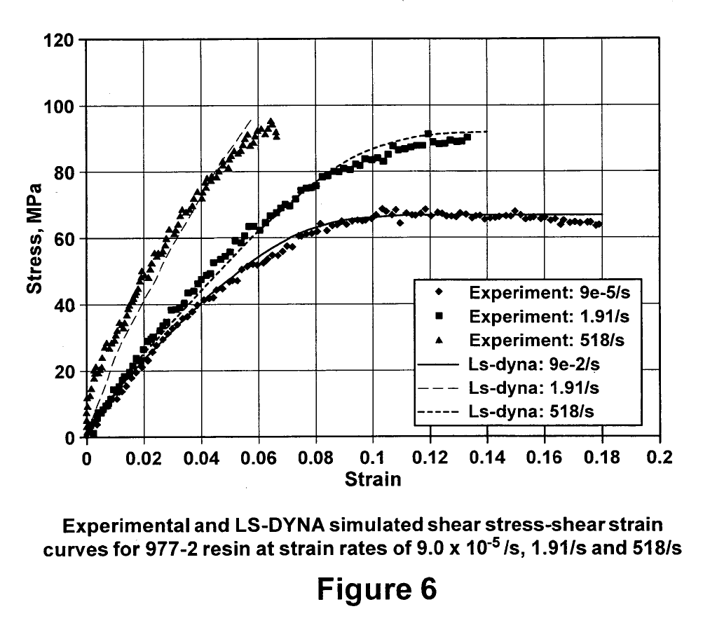

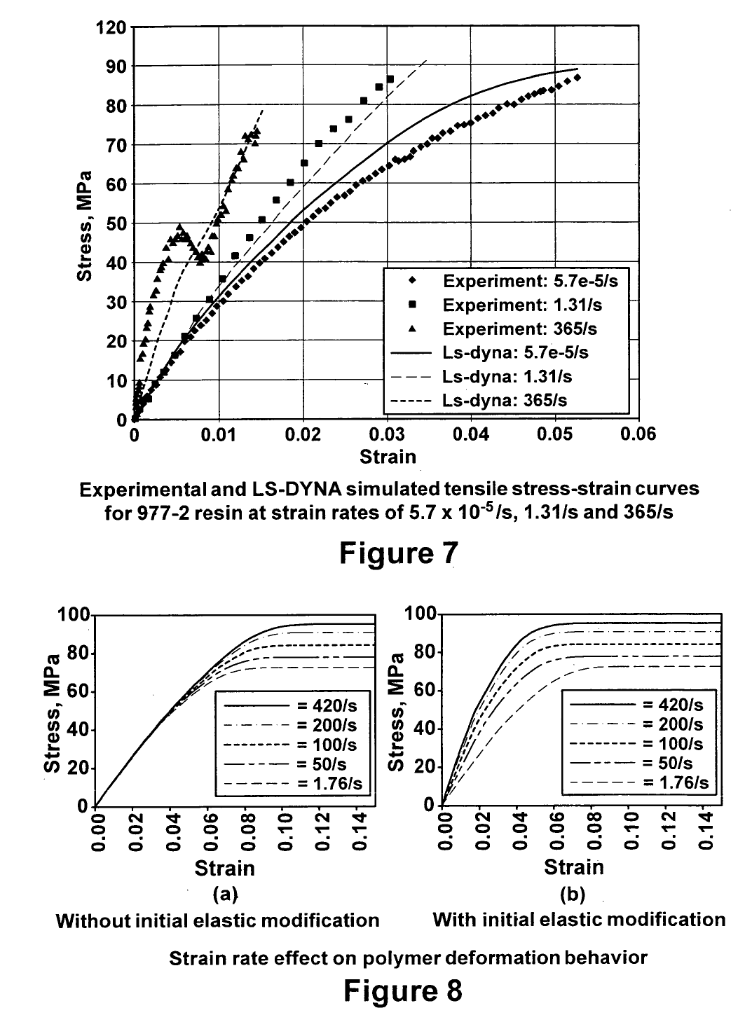

Experimental and computed shear stress-shear strain curves for PR520 are shown in FIG. 4 for the two strain rates considered, while tensile stress-strain curves are shown in FIG. 5. Experimental and computed shear stress-shear strain curves for 977-2 are shown in FIG. 6, and tensile stress-strain curves are shown in FIG. 7. Both materials exhibit a strain rate dependent, nonlinear deformation response under both shear and tensile loading. For the experimental data, at high strain rates, the sharp increase in stress at the beginning of the loading with negligible increase in strain observed for PR520 under shear and tensile loading is most likely not representative of the actual material behavior, but rather an artifact of the experimental tests. Also note that the oscillations observed in the high strain rate tensile tests for 977-2 were a result of the specimen geometry that was utilized for these tests.

From FIGS. 4 to 7, it can be seen that, though there is some underestimation of the tensile stresses, particularly in the case of PR520 under high strain rate tensile loading, the finite element results correlate well with the experimental data. The nonlinearity and rate dependence observed in the deformation of the two polymers are captured qualitatively, and the quantitative match between the experimental and computed results is reasonably good.

The effects of strain rate on the polymer deformation behavior are examined further in FIG. 8, where the shear deformation of PR520 is computed at various strain rates. In the results presented in FIG. 8(a) a fixed initial elastic modulus is used, while in FIG. 8(b), the initial elastic modulus is allowed to vary with strain rate as described in Equation (7). Both plots show that with increasing strain rate, the overall material stiffness increases and the stress level at which the stress-strain curve flattens out increases. However, by allowing the elastic modulus to vary with strain rate, the initial stiffness of the material response increases with increasing strain rate, which FIGS. 4 to 7 indicate is more representative of the actual polymer behavior.

Furthermore, for the case where the modulus varies with strain rate, the strain level at which the stress-strain curve flattens out decreases with increasing strain rate, where if the modulus is kept constant this strain level increases with increasing strain rate. FIG. 4 in particular appears to indicate that the strain at which the stress-strain curve flattens out does indeed decrease with increasing strain rate, indicating that allowing the modulus to vary with strain rate permits a more accurate representation of the polymer behavior.

One more important point to note is that the LS-DYNA simulated stress-strain curves have been artificially truncated at the experimental failure points. In this study, only the deformation response of polymers and polymer matrix composites is studied. Damage and failure models will be examined in future work.

Since the UMAT to analyze the bulk polymer was implemented successfully, the composite micromechanical model with the polymer constitutive equations incorporated was implemented into LS-DYNA as a UMAT as well. A series of analysis studies were then carried out to verify the finite element implementation of this model.

The composite material used for the verification studies consists of carbon IM7 fibers with a fiber volume ratio of 0.60 in the 977-2 toughened epoxy matrix discussed earlier. The IM7 fiber properties are as follows and are taken from Goldberg, et al. (see R. K. Goldberg et al., Implementation of an Associative Flow Rule Including Hydrostatic Stress Effects into the High Strain Rate Deformation Analysis of Polymer Matrix Composites, NASA/TM-2003-212382, 2003): E₁₁=276 GPa, E₂₂=13.8 GPa, v₁₂=0.25, v₂₃=0.25, G₁₂=20.0 GPa. The same properties for the 977-2 material as defined in Table 1 are used for the matrix phase in the composite model. The loading and boundary conditions used for the composite verification studies are identical to those used for the verification studies for the polymer constitutive equations. The fiber orientation of each lamina is defined for each through-thickness integration point of the shell element in the LS-DYNA input deck.

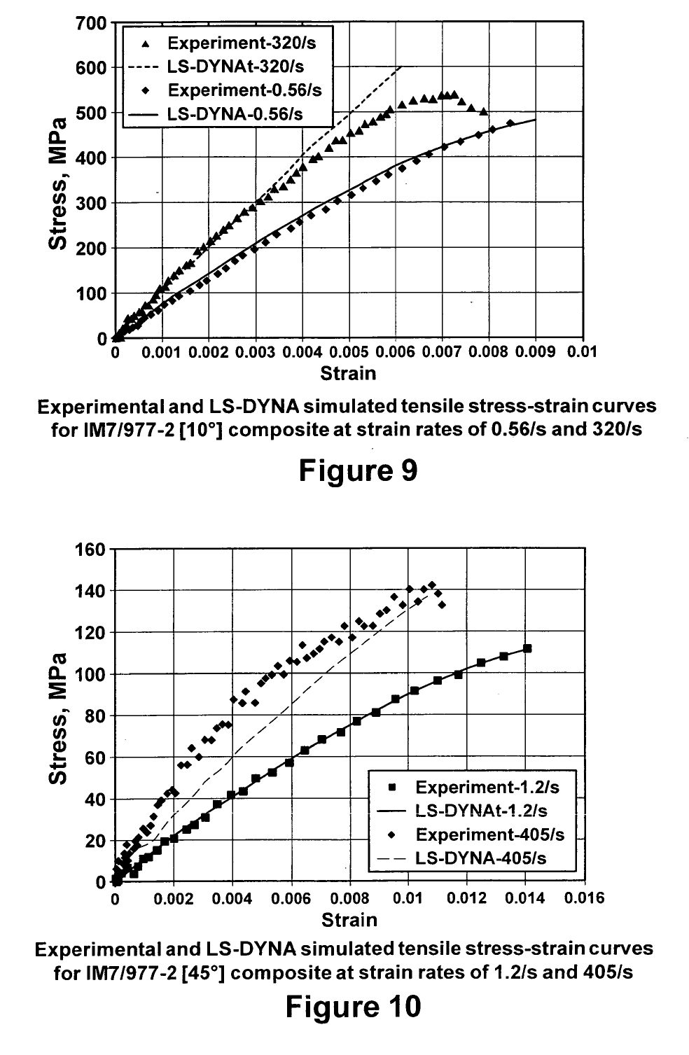

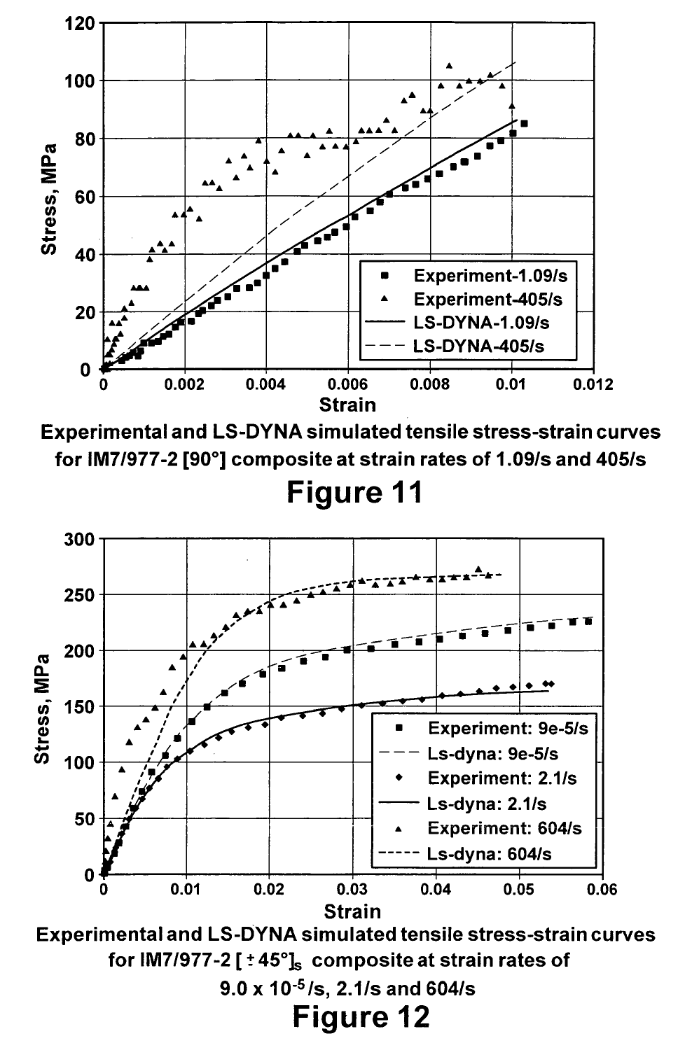

Experimental and predicted longitudinal tensile stress-strain curves for three laminate configurations ([10°], [45°] and [90°]) of the IM7/977-2 material at strain rates of approximately 1/s and 400/s are shown in FIGS. 9 to 11. In FIGS. 10 and 11, the experimental curve at the high strain rate shows a higher stress at the initial stage of loading than the numerical results. However, the high stress levels seen in the experimental results in the early portion of the stress-strain curve are most likely an artifact of the specimen geometry and the way the stress waves propagated through the specimen. At higher strain levels, the comparison is much improved, and the overall computations may actually be fairly accurate. In FIG. 9, at the high strain rate for higher strain levels the experimental curve flattens out where the computed curve does not, but this could be due to an early failure in the experimental specimen which is not captured by the analysis. The comparison between the experimental and numerical results is excellent for the low strain rate in all three of the laminate configurations.

As has been stated before, the composite UMAT is designed for a single ply. By defining the orientations of each through-thickness integration points in the shell elements, the UMAT can be used to simulate the behavior of composite laminate of various fiber configurations. The authors have attempted to simulate the experimental results of IM7/977-2 [±45°]ₛ laminate at strain rates of 9.0×10⁻⁵/s, 2.1/s and 604/s. Four through-thickness integration points have been defined in the shell element and oriented at +45°, −45°, −45° and +45°, respectively. Initially, the same values of α₀ and α₁ as in the previous simulations are used and it was found that the stresses are over predicted. By defining different values of α₀ and α₁ with α₀=0.0 and α₁=0.05215, good simulations are obtained as shown in FIG. 12. The reason may lie in the determination of α₀ and α₁. In this study, the values of α₀ and α₁ are determined based on the results of polymer uniaxial tension and pure shear tests. However, they can also be determined by the result of a uniaxial compression test in combination with either a pure shear or a uniaxial tension test. It is quite possible that a different approach may result in different values of α₀ and α₁. In the previous simulations, i.e., the polymer and unidirectional composite under tension, the hydrostatic stresses are all positive, while in a [±45°]ₛ laminate under tension, negative hydrostatic stresses are present. This may imply that positive and negative hydrostatic stresses may require modification of the equations by using different values of α₀ and α₁. Another cause of the discrepancies for this angle-ply laminate may be due to the thermal residual stresses.

State variable constitutive equations based on the Bodner viscoplasticity model have been modified to analyze the nonlinear, strain rate dependent deformation of polymers. The effects of hydrostatic stresses on the inelastic deformation and the effects of strain rate on the initial elastic modulus have been accounted for. The constitutive equations have been implemented within the LS-DYNA transient dynamic finite element code through the use of user defined material subroutines (UMATs). The tensile and shear deformation of two representative polymers have been accurately simulated using the polymer UMAT with the constitutive model.

The polymer constitutive equations were then implemented into a composite micromechanical model where the unit cell is divided into several independently analyzed slices. The composite model has also been implemented into LS-DYNA through the use of a UMAT. The tensile deformation of a representative polymer matrix composite was well predicted for three fiber orientations and two strain rates, indicating that the composite UMAT is able to capture the important features of the deformation response. There were some discrepancies between the simulated and experimental results for the high strain rate cases, but these were most likely due to conditions present in the experimental tests.

The method of the present invention can be used to analyze the strain rate dependence of various polymer composites in any number of situations. For example, polymer composites used in aerospace applications, military applications, automotive/vehicle applications and sporting goods applications can be analyzed via the present invention. It should be noted however, that the present invention is not limited to just polymer composites used in the above-mentioned technical areas. Rather, the present invention can be utilized in are technical area/industry in which polymer composites are exposed to, for example, high strain rate impact conditions.

Although the invention has been described in detail with particular reference to certain embodiments detailed herein, other embodiments can achieve the same results. Variations and modifications of the present invention will be obvious to those skilled in the art, and the present invention is intended to cover in the appended claims all such modifications and equivalents.

1. A method for analyzing the strain rate dependence of a polymer composite, the method comprising the steps of:
(A) a means for calculating at least one stress tensor value (σᵢⱼ), wherein the means employs the formula shown below:
$$\begin{matrix}[ \begin{matrix}{ɛ}_{11}^{e} \\ {ɛ}_{22}^{e} \\ {ɛ}_{33}^{e} \\ {ɛ}_{23}^{e} \\ {ɛ}_{13}^{e} \\ {ɛ}_{12}^{e}\end{matrix} ] = [ \begin{matrix}{ɛ}_{11} \\ {ɛ}_{22} \\ {ɛ}_{33} \\ {ɛ}_{23} \\ {ɛ}_{13} \\ {ɛ}_{12}\end{matrix} ] - [ \begin{matrix}{ɛ}_{11}^{I} \\ {ɛ}_{22}^{I} \\ {ɛ}_{33}^{I} \\ {ɛ}_{23}^{I} \\ {ɛ}_{13}^{I} \\ {ɛ}_{12}^{I}\end{matrix} ] \\ = [ \begin{matrix}\frac{1}{{E}_{m}} & - \frac{{v}_{m}}{{E}_{m}} & - \frac{{v}_{m}}{{E}_{m}} & 0 & 0 & 0 \\ - \frac{{v}_{m}}{{E}_{m}} & \frac{1}{{E}_{m}} & - \frac{{v}_{m}}{{E}_{m}} & 0 & 0 & 0 \\ - \frac{{v}_{m}}{{E}_{m}} & - \frac{{v}_{m}}{{E}_{m}} & \frac{1}{{E}_{m}} & 0 & 0 & 0 \\ 0 & 0 & 0 & \frac{2 ( 1 + {v}_{m} )}{{E}_{m}} & 0 & 0 \\ 0 & 0 & 0 & 0 & \frac{2 ( 1 + {v}_{m} )}{{E}_{m}} & 0 \\ 0 & 0 & 0 & 0 & 0 & \frac{2 ( 1 + {v}_{m} )}{{E}_{m}}\end{matrix} ] \\ [ \begin{matrix}{σ}_{11} \\ {σ}_{22} \\ {σ}_{33} \\ {σ}_{23} \\ {σ}_{13} \\ {σ}_{12}\end{matrix} ]\end{matrix}$$
where εᵢⱼ^{e} is the elastic strain tensor, is the inelastic strain tensor, εᵢⱼ is the total strain tensor which equals to the summation of εᵢⱼ^{e} and εᵢⱼ^{I}, Eₘ is the polymer modulus, and νₘ is the Poisson ratio; and
(B) a means for utilizing the stress tensor value or values (σᵢⱼ) from Step (A) to derive at least one deviatoric stress component Sᵢⱼ.

2. The method of claim 1, wherein Eₘ is modified using the following equation:
$$E = {E}_{0} ( 1 + C ln \frac{\dot{ɛ}}{{\dot{ɛ}}_{0}} ) \qquad ( 7 )$$
where C is a scaling material constant, E is the final elastic modulus, E₀ is the reference elastic modulus, \dot{ε}₀ is the reference effective strain rate, and \dot{ε} is the applied effective strain rate, wherein the effective strain rate \dot{ε} is defined as:
$$\dot{ɛ} = \sqrt{\frac{2}{3} [ \begin{matrix}{( {\dot{ɛ}}_{11} - {\dot{ɛ}}_{m} )}^{2} + {( {\dot{ɛ}}_{22} - {\dot{ɛ}}_{m} )}^{2} + {( {\dot{ɛ}}_{33} - {\dot{ɛ}}_{m} )}^{2} + \\ 2 {\dot{ɛ}}_{12}^{2} + 2 {\dot{ɛ}}_{23}^{2} + 2 {\dot{ɛ}}_{13}^{2}\end{matrix} ]} )$$
$$where {\dot{ɛ}}_{m} = \frac{1}{3} ( {\dot{ɛ}}_{11} + {\dot{ɛ}}_{22} + {\dot{ɛ}}_{33} ) .$$

3. A method for analyzing the strain rate dependence of a polymer composite, the method comprising the steps of:
(i) a means for determining one or more material constants, wherein the means for determining one or more material constants include a storage means for storing the one or more material constants;
(ii) a means for determining one or more strain increments, wherein the means for determining one or more strain increments include a second storage means for storing the one or more strain increments; and
(iii) using the data for Step (i) and/or (ii) to analyze the strain rate dependence of a polymer composite.

4. The method of claim 3, wherein the means for determining one or more material constants includes determining at least one stress tensor value (νᵢⱼ), wherein the at least one stress tensor value (σᵢⱼ) employs the formula shown below:
$$\begin{matrix}[ \begin{matrix}{ɛ}_{11}^{e} \\ {ɛ}_{22}^{e} \\ {ɛ}_{33}^{e} \\ {ɛ}_{23}^{e} \\ {ɛ}_{13}^{e} \\ {ɛ}_{12}^{e}\end{matrix} ] = [ \begin{matrix}{ɛ}_{11} \\ {ɛ}_{22} \\ {ɛ}_{33} \\ {ɛ}_{23} \\ {ɛ}_{13} \\ {ɛ}_{12}\end{matrix} ] - [ \begin{matrix}{ɛ}_{11}^{I} \\ {ɛ}_{22}^{I} \\ {ɛ}_{33}^{I} \\ {ɛ}_{23}^{I} \\ {ɛ}_{13}^{I} \\ {ɛ}_{12}^{I}\end{matrix} ] \\ = [ \begin{matrix}\frac{1}{{E}_{m}} & - \frac{{v}_{m}}{{E}_{m}} & - \frac{{v}_{m}}{{E}_{m}} & 0 & 0 & 0 \\ - \frac{{v}_{m}}{{E}_{m}} & \frac{1}{{E}_{m}} & - \frac{{v}_{m}}{{E}_{m}} & 0 & 0 & 0 \\ - \frac{{v}_{m}}{{E}_{m}} & - \frac{{v}_{m}}{{E}_{m}} & \frac{1}{{E}_{m}} & 0 & 0 & 0 \\ 0 & 0 & 0 & \frac{2 ( 1 + {v}_{m} )}{{E}_{m}} & 0 & 0 \\ 0 & 0 & 0 & 0 & \frac{2 ( 1 + {v}_{m} )}{{E}_{m}} & 0 \\ 0 & 0 & 0 & 0 & 0 & \frac{2 ( 1 + {v}_{m} )}{{E}_{m}}\end{matrix} ] \\ [ \begin{matrix}{σ}_{11} \\ {σ}_{22} \\ {σ}_{33} \\ {σ}_{23} \\ {σ}_{13} \\ {σ}_{12}\end{matrix} ]\end{matrix}$$
where εᵢⱼ^{e} is the elastic strain tensor, εᵢⱼ^{I} is the inelastic strain tensor, εᵢⱼ is the total strain tensor which equals to the summation of εᵢⱼ^{e} and εᵢⱼ^{I}, Eₘ is the polymer modulus, and νₘ is the Poisson ratio; and wherein the at least one stress tensor value (σᵢⱼ) is used to derive at least one deviatoric stress component Sᵢⱼ.

5. The method of claim 4, wherein Eₘ is modified using the following equation:
$$E = {E}_{0} ( 1 + C ln \frac{\dot{ɛ}}{{\dot{ɛ}}_{0}} ) \qquad ( 7 )$$
where C is a scaling material constant, E is the final elastic modulus, E₀ is the reference elastic modulus, \dot{ε}₀ is the reference effective strain rate, and \dot{ε} is the applied effective strain rate, wherein the effective strain rate \dot{ε} is defined as:
$$\dot{ɛ} = \sqrt{\frac{2}{3} [ \begin{matrix}{( {\dot{ɛ}}_{11} - {\dot{ɛ}}_{m} )}^{2} + {( {\dot{ɛ}}_{22} - {\dot{ɛ}}_{m} )}^{2} + {( {\dot{ɛ}}_{33} - {\dot{ɛ}}_{m} )}^{2} + \\ 2 {\dot{ɛ}}_{12}^{2} + 2 {\dot{ɛ}}_{23}^{2} + 2 {\dot{ɛ}}_{13}^{2}\end{matrix} ]} )$$
$$where {\dot{ɛ}}_{m} = \frac{1}{3} ( {\dot{ɛ}}_{11} + {\dot{ɛ}}_{22} + {\dot{ɛ}}_{33} ) .$$
